(19) United States
(12) Patent Application Publication
(10) Pub. No.: US 2002/0188635 A1
(43) Pub. Date: Dec. 12, 2002

(54) System and method for incorporation of print-ready advertisement in digital newspaper editions

(76) Inventor: Stephen C. Larson, Clifton Springs, NY (US)

Correspondence Address: GREENWALD & BASCH, LLP, 349 WEST COMMERCIAL STREET, SUITE 2490, EAST ROCHESTER, NY, 14445, US

(21) Appl. No.: 10/092,674

(22) Filed: Mar. 7, 2002

Related U.S. Application Data
(60) Provisional application No. 60/278,675, filed on Mar. 20, 2001.

(51) Int. Cl. G06F 15/00

(52) U.S. Cl. 707/515

(57) ABSTRACT

The present invention is a method and apparatus for preparing a web page for a digital edition of a newspaper, newsletter, or magazine using print media display advertisements as input, so that a publisher may offer to advertisers both hard copy print and web site advertising opportunities without requiring the modification of advertising copy to fit the web and to give the advertiser the benefit of displaying their ad next to the news/editorial content on the web. The method uses display advertising created for print, such as scanned hard copy or other electronic print-formatted copy, to produce full-size images linked from “preview” images displayed next to news/editorial content on the web site that maintain the aspect ratio of the full-size advertisement, while altering their size both in terms of number of bytes and space required to display. The advertising copy is then programmed to automatically appear at a position adjacent news/editorial content in a manner familiar to readers (e.g., ads next to news/editorial content).

### CROSS-REFERENCE

The present application is based upon, and hereby incorporates by reference, U.S. Provisional Patent Application for a “SYSTEM AND METHOD FOR INCORPORATION OF PRINT READY ADVERTISEMENT IN DIGITAL NEWSPAPER EDITIONS,” Application No. 60/278,675, filed Mar. 20, 2001 by Stephen C. Larson, in its entirety.

This invention relates generally to an on-line publishing system and the use of print-ready content in a digital newspaper, and more particularly to a system and method for preparing a web page for a digital edition of a newspaper, newsletter, or magazine, utilizing print media display advertisements as input.

### COPYRIGHT NOTICE

A portion of the disclosure of this patent document, and material incorporated by reference herein, contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND AND SUMMARY OF THE INVENTION

With the present invention a publisher may offer to advertisers both hard copy print and web site advertising opportunities without requiring the modification of advertising copy for the web and give the advertiser the benefit of displaying their ad next to the news and other content on the web. One method uses display advertising created for print, such as scanned hard copy or other electronic print-formatted copy, to produce full-size images linked from “preview” images displayed next to content on the web site. In most cases, preview images are reduced in size both in terms of number of bytes and the space required to display. The preview image of the display ad copy is programmed to automatically appear at a position adjacent to content in a manner familiar to readers (e.g., ads next to content) and to change position as different pages are viewed.

The present invention is a system and method for preparing a web page for a digital edition of a newspaper or magazine using print media input for both news/editorial content, calendar(s), community guide(s) or information, text-based classified (liner ads) and other advertisement, so that a publisher may offer to advertisers both hard copy print and web site advertising opportunities without requiring the advertiser to alter their advertising copy. The method uses existing display advertising, such as hard copy or other print-formatted copy, to produce both full-size images and reduced-size or “preview” images that provide a best-fit and/or maintain the aspect ratio of the full-size advertisement, while reducing their size (including width, height and color gamut) to fit into a web site and to obtain reasonable download times. For example, the advertising copy may be programmed to appear at a position adjacent news/editorial content in a manner familiar to readers. The web page is then composed using the news/editorial content in conjunction with the advertisement.

Use of the system and method results in improved layout for web sites, particularly sites associated with newspapers, where a web page advertiser is not restricted to a banner or similar advertising format. Furthermore, the preview images that appear on the web pages are also hyperlinked to the full-size images, so that a user can review, in a larger format, the details of the advertisement, print associated coupons, etc. Accordingly, the system produces digital edition web pages that incorporate preview images of advertising hard copy.

It is further contemplated that the system for implementing the method described above may include an automated computer system that digitizes and/or processes the advertising materials so as to automatically produce digital images suitable for association or incorporation within the web page, including hyperlinking. Furthermore, such a system may include automated accounting or other processes so as to assure the advertisement control and accurate billing of advertisers who choose to place both print and on-line advertising.

Heretofore, a number of patents and publications have disclosed aspects of the preparation of newspapers and on-line advertising using computer technology, the relevant portions of which are hereby incorporated by reference for their teachings, and may be briefly summarized as follows:

The NewsMaker & HTML Generation pages from Comyan (www.comyan.com/newsmaker-htmigen.htm) disclose tools for the conversion of newspaper content to digital/on-line editions suitable for world-wide web display.

SmallTownPapers . . . your digital newsstand (http://smalltownpapers.com) pages are examples of thumbnail images for full-page versions of a local paper. By clicking on the link, the user is presented with a GIF image of the page, including content and advertisements, as printed. Also, www.hotcoupons.com includes advertisements as well, however, unlike the present invention the ads must be sought out by the readers. The present invention displays previews of the ads when the reader is reading other material, whereas the www.hotcoupons.com reader must look in specific categories for ads.

U.S. Pat. No. 5,557,728 for Automated Image Retrieval and Scaling Into Windowed Displays describes at columns 1 and 2, describes fixed-size icons of image data that may be presented to display search results.

U.S. Pat. No. 5,740,549 for an Information and Advertising Distribution System and Method, graphically depicts a display screen where article content is displayed adjacent to an advertisement image (FIG. 10; 258). Moreover, at col. 1, lines 47-65, there is a general description of the publication of newspapers on the Internet. The patent further describes, at col. 14 (top) a system where a subscriber may click on a displayed advertisement and is linked (automatically connected) to an associated world-wide web page.

U.S. Pat. No. 5,819,032 for an Electronic Magazine Which is Distributed Electronically from a Publisher to Multiple Subscribers teaches the network distribution of publications, and notes at the bottom of col. 2 that title and picture boxes, associated with an article via a database, may also be displayed.

U.S. Pat. No. 5,860,074 for a Method and Apparatus for Displaying an Electronic Document with Text Over Object teaches the use of thumbnail images of pages (FIG. 2b) that may be incorporated within a document to facilitate navigation. Also disclosed at col. 37 (middle) is the fact that the invention may be applied to a digital newspaper in order to facilitate the access to articles that run across multiple pages.

U.S. Pat. No. 5,953,733 for an Electronic Publishing System is directed to a system for assisting in the design and particularly layout of a newspaper or similar publication.

U.S. Pat. No. 6,011,537 is directed to a System for Delivering and Simultaneously Displaying Primary and Secondary Information, and for Displaying only the Secondary Information During Interstitial Space, and teaches the use of key-hole images (small region of larger image) as a link to the larger image (e.g., FIG. 10).

U.S. Pat. No. 6,049,785 for an Open Network Payment System for Providing for Authentication of Payment Orders Based on a Confirmation Electronic Mail Message teaches a system having a database of digital advertisements.

U.S. Pat. No. 6,081,277 for an Apparatus and Method for Controlling Image Display teaches an image display where portions of the display, when selected, may be depicted in a full-size format, and when not selected may be shown in a reduced-size format (e.g., FIGS. 22-24).

In accordance with the present invention, there is provided an on-line newspaper publishing system for the preparation of one or more publications, including: a networked host server; a composition computer connected to said host server; and an image database, associated with the server and accessible by the composition computer, that defines at least the following: content to be prepared for publication in a digital edition hosted on the host server, at least one layout template wherein the template defines at least a region on a web page for the display of a preview image of a display advertisement, image files, including images of full-size display advertisements and corresponding reduced-size preview images, and browser-readable code representing a web page, wherein the web page has at least one link to an image file.

In accordance with another aspect of the present invention, there is provided a method of preparing an on-line news publication via an electronic publishing system in a computer, the method including the steps of: collecting advertiser digital copy from a print media source; creating, using an image size reduction operation, a reduced-size preview image of the advertiser digital copy, wherein at least one dimension of the preview image is determined in accordance with a predetermined size; associating text-based content with the preview image in a web page, wherein the preview image is a selectable object that is linked to a full-size image of the advertiser copy; and publishing the web page to the Internet.

In accordance with yet another aspect of the present invention, there is provided a method of preparing an on-line news publication web page, including display advertising for distribution via the Internet, the method including the steps of: determining the size of full-size display advertisement images to be incorporated into the web page; sorting the full-size display advertisement images into at least two groups of images based upon image size; successively opening each of the sorted image files, resizing the file so as to adjust the size to meet at least one dimensional requirement of the web page, and saving the resized image data as a preview file; incorporating the preview file into the web page; and uploading the web page for access by other computers connected to the Internet.

The present invention contemplates the automated positioning of advertising, including positioning: 1) by section, specific page or position; 2) in locations other than the right hand column; 3) via additional controls including start and stop dates, number of displays and/or click-through features; and 4) that involves evenly distributing displays over a given period. Furthermore, statistics and billing information collected with respect to such display advertisements may include: 1) reports indicating the number of times ads are displayed, the page(s) they are displayed on and, the number of times full size images are displayed at the viewer's request, etc.; and 2) generation and tracking of bills to advertisers.

One aspect of the invention deals with a basic problem in the display of Internet or world-wide web advertising—the advertisements are disassociated with the content they are typically associated with. For example, banner advertising is found on many websites, but the banner is either always there or is moved from view as the user scrolls down in the browser window to see the web page content. Both of these are atypical of the traditional reader experience with hard-copy media such as newspapers, magazines, etc. where users are accustomed to seeing advertisement adjacent to the content.

This aspect is further based on the discovery of a technique that alleviates this problem and improves the efficiency of producing on-line advertisements from print-formatted advertising copy. The technique employed automates the process by which print-formatted advertisement may be displayed in web pages. In particular, the technique utilizes reduced-size preview images to simulate print-media format, with the reduced-size preview images being selectable links to the full-size images of the advertising copy. The techniques described herein are advantageous because they are both efficient and inexpensive ways to utilize print-ready advertising copy for on-line advertisements in digital newspapers. The techniques allow publishers and advertisers to avoid the cost of developing or reformatting advertising to fit traditional banner-type advertising in the on-line realm. As a result of the invention, newspaper publishers and their advertisers are able to quickly produce and host on-line editions of their newspapers with immediate on-line advertising revenue.

### BRIEF DESCRIPTION OF THE DRAWINGS

FIG. 1 is a schematic illustration of a network-based embodiment for the a digital newspaper hosting system in accordance with the present invention;

FIGS. 2-4 are exemplary illustrations of user-interface screens in the form of a web browser interface in accordance with an aspect of the present invention;

FIG. 5 is a schematic illustration of the flow of data during a response to a server request;

FIG. 6 is a hierarchical menu schema for exemplary newspapers hosted by the system of FIG. 1;

FIG. 7 is a schematic illustration of a display advertisement production system; and

FIGS. 8 is a flow diagram illustrating the various steps executed in the creation of a digital newspaper and display advertising in association with a print newspaper in accordance with an aspect of the present invention.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENT

For a general understanding of the present invention, reference is made to the drawings. In the drawings, like reference numerals have been used throughout to designate identical elements. In describing the present invention, the following term(s) have been used in the description. “User input circuitry” is circuitry for providing signals based on actions of a user, and can receive signals from one or more “user input devices” that provide signals based on actions of a user, such as a keyboard or a mouse. The set of signals provided by user input circuitry can therefore include at least data indicating mouse operation and data indicating keyboard operation. Signals from user input circuitry may include a “request” for an operation, in which case a system may perform the requested operation in response. User input circuitry may further include imaging or digitizing devices such as digital cameras and scanners, where an image may be captured and rendered as digital signals.

A wide variety of display apparatus and techniques for data processing and networked computer systems are available including, for example, various displays and graphical user interfaces. In this application, the term “display feature” refers to any human perception produced by a display, including user-interfaces such as Microsoft's Windows®, and network browsers.

A “display object” or “object” is a display feature that is perceptible as a coherent unity. A “region” on a display is a bounded area of the display; for example, a single point is the smallest possible region of any display. A “shape” is a display object that has a distinguishable outline; for example, a circular display object is a shape. An “image” is a display object that is produced within a region from data defining the image (e.g., a graphic image file format such as gif, .jpg, tiff, .bmp, .pdf, etc. A “structure” is a display feature that includes other display features within it, all of which appear to be connected into a unity.

A “hierarchical structure” is a structure that is perceptible as having a number of levels. For example, a hyperlinked document (e.g., an HTML document displayable by a browser), may include links not only to other portions of the document itself (same level), but also to other documents, images, lists of links, etc. that would be at a lower level.

A “scene” is a series of one or more images that can be presented by a sequence of animation cycles such that display features appear to continue through the scene. Data “defines” a scene when it can be used to produce data defining the images of the scene.

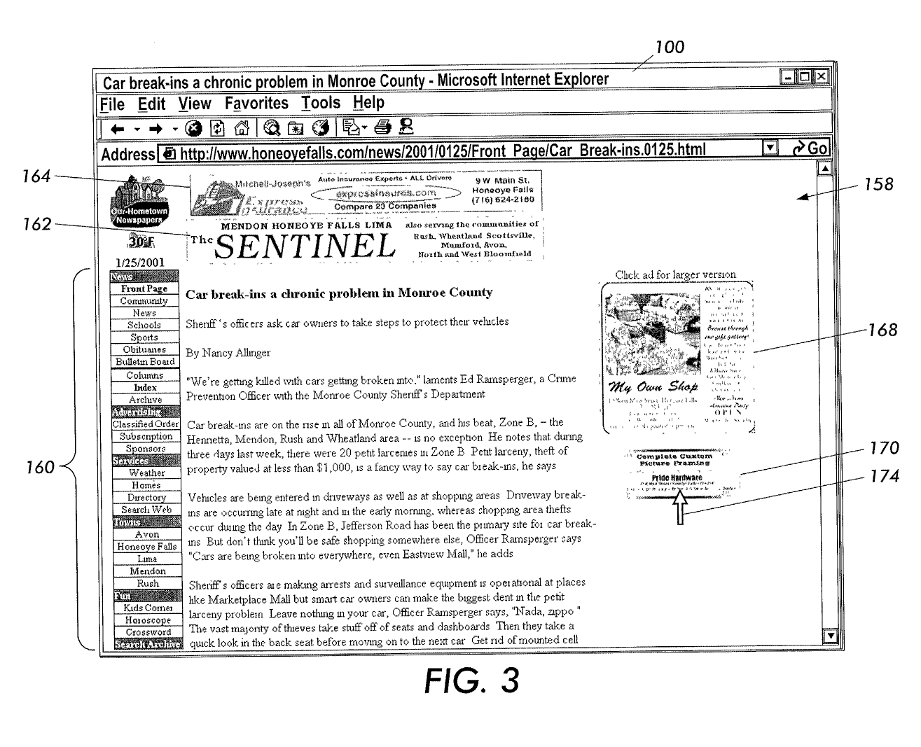

A “selectable unit” is a display feature that is perceived as a bounded display area that can be selected. For example a hyperlinked “button” or “box” in region 160 of FIG. 3 is a selectable unit within a web browser interface. The user can, for example, use a pointing device such as a mouse to select a selectable unit by indicating its position and clicking a button on the pointing device.

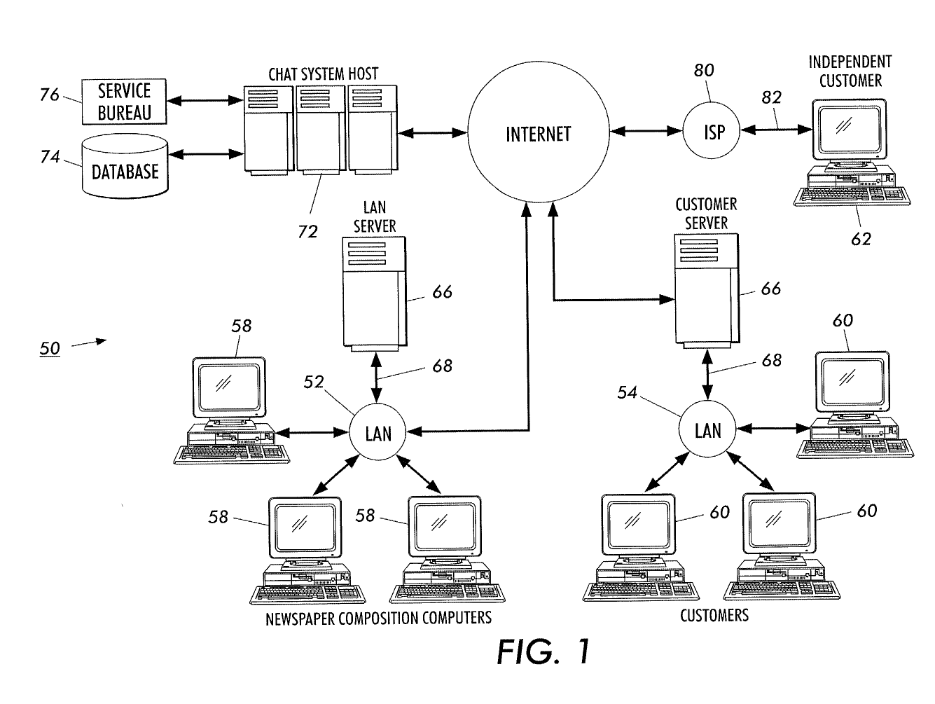

Turning now to FIG. 1, there is depicted a schematic illustration of a computer network-based embodiment for a system in accordance with the present invention. In particular, the embodiment depicted is a network utilizing the Internet as the network. In particular, the system includes a data processing network 50 in which the present invention may be practiced. The data processing network 50 includes a plurality of individual networks, including LANs 52 and 54, each of which includes a plurality of composition workstations 58, individual workstations 60 or single-user workstations 62. It will be further appreciated that such workstations generally include a processor, display and one or more user input devices such as a keyboard or a mouse. Alternatively, as will be appreciated by those skilled in the art, a LAN may comprise a plurality of intelligent workstations coupled to a host processor.

The data processing network 50 of FIG. 1 may also include mainframe computers 66 that may be coupled to the LAN 52 by means of a communications link 68. As will be appreciated by those skilled in the art, the term network includes both wired and wireless communication technologies, and the equipment associated therewith (e.g., personal computers, personal digital assistant (PDA) devices, cellular and digital telephones, etc.).

Similarly, LAN 52 and composition workstations 58 may be coupled, via the network, to a host server 72. In one embodiment, the host server is employed to “host” the data necessary for a plurality of digital newspaper editions, and is located within a secured facility with an OC-3 communications backbone and redundant connections. It will be further appreciated that, although not depicted in FIG. 1, such a system would further include an on-site uninterruptible power supply (UPS) and backup generator(s). Moreover backups of host server storage media (e.g., hard drives) that include database 74 may be made regularly and stored offsite in order to provide archives for data recovery.

The host server 72 is preferably an individual computer or intelligent workstation associated with newspaper service bureau 76 that is connected to other networked computers via an Internet or similar connection. It will be appreciated that the various components described in FIG. 1 may be co-located or separated by a significant geographic distance, and similarly, that the LANs 52 and 54 may be located a substantial distance from one another.

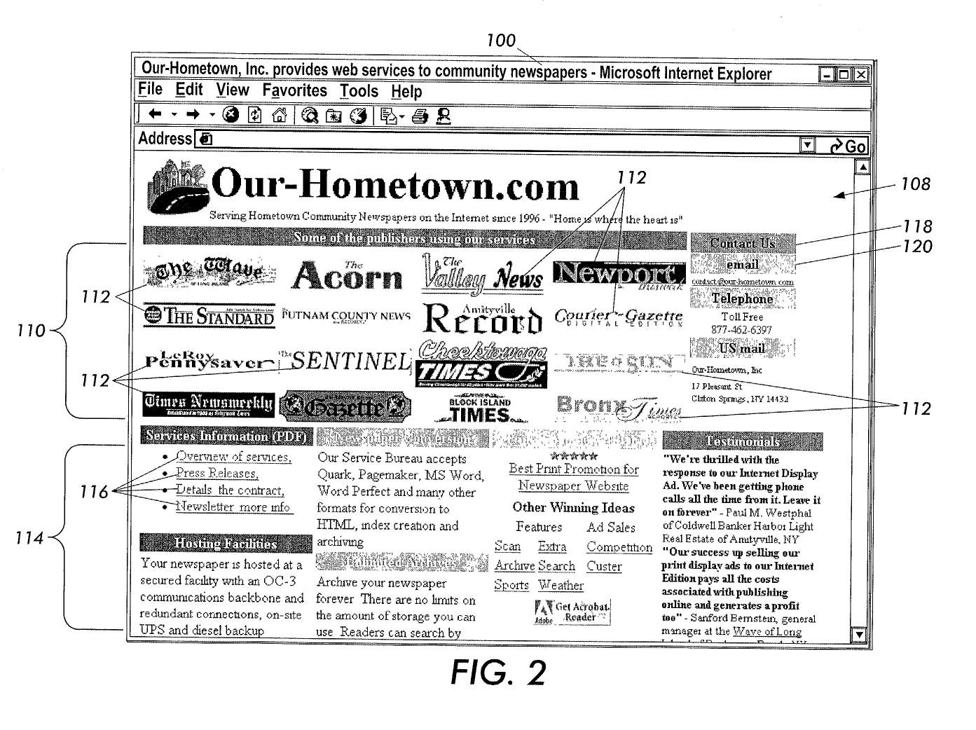

Various aspects of the present invention are implemented using well-known hyper-text markup language (HTML), Java and similar coding techniques to implement the on-line editions of local newspapers as depicted, for example, in FIG. 2. Such a user-interface is created by well-known browser software (e.g., Netscape Navigator, Microsoft Internet Explorer), which interprets the HTML/Java code to render a display feature or scene in accordance with an aspect of the present invention. In particular, HTTP server software operating on host server 72 serves to create or generate the HTML or equivalent code that is distributed to customer computers 60. The operating software resident on the host combines content, advertisement, and advertising (including banners) to create the user-viewable image displayed in FIG. 3. Furthermore, the operating software may include additional functionality to, for example, count how many times a page or advertisement is displayed, controls banner and display advertising by the number of hits and/or date, as well as count clicks on the advertising (click-through). Lastly, as illustrated in FIG. 3, the operating software also merges the content and advertising with the navigational features required for a page so that content is seamlessly combined with advertising and navigation objects. Thus, when a content file is served, it finds contents and images (display and banner advertising) to compose the web page for download in real-time.

In a client-server environment, such software programming code may be stored in memory or a storage means associated with a server. The software programming code may be embodied on any of a variety of known media for use with a data processing system, such as a diskette, hard drive, or CD-ROM. The code may be distributed on such media, or may be distributed to users from the memory or storage means of one computer system over a network of some type (e.g., Internet) to other computer systems for use by users of such other systems. The techniques and methods for embodying software programming code in memory, on physical media, and/or distributing software code via networks are well known and will not be further discussed herein.

The data stream resulting from the use of the present invention may be stored on any of the various media types used by the long-term storage where database 74 resides, or may be sent from a workstation 60 to another computer or workstation of the network illustrated in FIG. 1 over the communications channels.

In a preferred embodiment, the programs used to perform aspects of the present invention are implemented in a stand-alone fashion, one or more of which may be employed to produce a portion of the scene depicted in a browser window as will be described in further detail below. Use of the term “Internet” herein, when discussing processing associated with the user's request, includes processing that occurs in an intranet, unless otherwise stated.

Referring also to FIG. 2, the host server 72, having been programmed via the service bureau and operating on data input via composition computers 58, “hosts” at least one Internet web site that is depicted in browser window 100 of FIG. 2. Customers may access the web site via LAN connected workstations 60 or via independent computers 62 (which are understood to include wireless and personal digital assistant (PDA) devices as well) connected via an independent service provider 80 and connection 82. Again connection 82 may be wired or wireless, and includes modem connections via a telephone network and cable-modem connections on a cable television network.

Having described an embodiment for the present invention, attention is now turned to FIG. 2, which shows a browser window 100 with a web page 108 displayed therein as would be viewed by a user of computer workstations 60 or 62 in FIG. 1. Within window 100, there is a plurality of objects. Region 110 includes the digital images of the hosted newspaper flags, logotypes or nameplates 112. Below region 108 is a region 114, which includes textual information and text hyperlinks 116. Also included on the web page 108 are objects such as “buttons” or rectangular shaped objects for linking to, for example, contact information (button 118) and an e-mail address (button 120). The order and characteristics of the button displayed on a web page are determined by a “button” file, read by the operating software and incorporated into the page as it is being “served.” The various images used to depict the flags, logotypes or nameplates are not embedded within the code for web page 108, but are linked images from an image database 74, where the images are accessed by the operating software of the server in response to a server request for download of the HTML code for the web page. An exemplary portion of the code is found below:

<!doctype html public “-//w3c//dtd html 4.0 transitional//en”>
<html>
<head>
<meta name=“Author” content=“Stephen Larson”>
<meta name=“GENERATOR” content=“Mozilla/4.5 [en] (Win95; I) [Netscape]”>
<title>Our-Hometown, Inc. provides web services to community newspapers</title>
</head>
<body text=“#000000” bgcolor=“#FFFFFF” link=“#0000EE” vlink=“#551A8B”
alink=“#FF0000”>
<table BORDER=0 CELLPADDING=1 CELLSPACING=3>
<tr>
<td ALIGN=CENTER COLSPAN=4>
<table border=0 CELLSPACING=0 CELLPADDING=0>
<tr><td VALIGN=MIDDLE ALIGN=CENTER><img BORDER=0 SRC=“newtown.gif”
BORDER=0 height=72 width=72>
</td>
<td>
<b><font size=+4>Our-Hometown.com</font></b>
<br><font size=−1>Serving Hometown Community Newspapers on the Internet since 1996 -
“Home is where the heart is”</font>
</td>
</tr>
</table>
<tr>
<td COLSPAN=“4” BGCOLOR=“#008200”>
<center><b><font color=“#FFFFFF”>Some of the publishers using our
services</font></b></center>
</td>
<td ROWSPAN=6 VALIGN=TOP>
<table BORDER=0 CELLPADDING=2 CELLSPACING=0>
<tr>
. . .
<td><a HREF=“http://www.rockawave.com”><img SRC=“wave-small.gif” ALT=“The Wave”
BORDER=0 height=36 width=150></a></td>
<td><a HREF=“http://www.toacorn.com/”><img SRC=“The_Acorn_Logo.gif” ALT=“The
Acorn” BORDER=“0” height=“38” width=“150”></a></td>
<td><a HREF=“http://www.valleynewsonline.com/”><img SRC=“vn_150.gif” ALT=“Valley
News” BORDER=“0” height=“54” width=“150”></a></td>
<td><a HREF=“http://www.NewportThisWeek.com/”><img SRC=“newport_150.gif”
ALT=“Newport This Week” BORDER=“0” height=“33” width=“150”></a></td>
</tr>
<tr>
<td><A HREF=“http://www.bcstandard.com”><img SRC=“bcstndrdsm.gif” ALT=“Baker
County Standard” BORDER=0 height=29 width=150 BORDER=0></A></td>
<td><a HREF=“http://www.pcnr.com”><img SRC=“pcnrlogo.gif” ALT=“Putnam News”
BORDER=0 height=30 width=150></a></td>
<td><a HREF=“http://www.AmityvilleRecord.com/”><img SRC=“record_150.gif”
ALT=“Amityville Record” BORDER=0 height=36 width=150></a></td>
<td><a HREF=“http://www.cgazette.com”><img SRC=“CG-small.gif” ALT=“Courier
Gazette” BORDER=0 height=32 width=150></a></td>
</tr>
<tr>
<td><A HREF=“http://www.leroyny.com/”><img SRC=“leroy-small.gif” ALT=“LeRoy
Pennysaver” BORDER=0 height=30 width=150 BORDER=0></A></td>
<td><a HREF=“http://www.honeoyefalls.com/”><img SRC=“sentinel-small.gif” ALT=“The
Sentinal” BORDER=“0” height=“31” width=“150”></a></td>
<td><A HREF=“http://www.CheektowagaTimes.com/”><img SRC=“ctlogosm.gif”
ALT=“Cheektowaga Times” BORDER=0 height=56 width=150 BORDER=0></A></td>
<td><a HREF=“http://www.SheridanSun.com”><img SRC=“sunLogo_150.gif” ALT=“Sheridan
Sun” BORDER=“0” height=“24” width=“150”></a></td>
</tr>
<tr>
<td><a HREF=“http://www.timesnewsweekly.com”><img SRC=“timeslogo.gif”ALT=“Times
News Weekly” BORDER=0 height=29 width=150></a></td>
<td><a HREF=“http://www.qgazette.com/”><img SRC=“QG-small.gil” ALT=“Queens
Gazette” BORDER=“0” height=“36” width=“150”></a></td>
<td><A HREF=“http://www.BlockIslandTimes.com”><img SRC=“bit.gif” ALT=“Block Island
Times” BORDER=0 height=36 width=150 BORDER=0></A></td>
<td><a HREF=“http://www.bxtimes.com/”><img SRC=“Bronx150.gif” ALT=“Bronx Times”
BORDER=0 height=30 width=150></a></td>
</tr>
</table>
<table ALIGN=LEFT BORDER=0 WIDTH=“200”>
<tr>
. . .

As will be appreciated, the flags, logotypes or nameplates images are stored in a graphics interchange format (.gif) file, however alternative file formats may also be employed. The hierarchical structure of web page 108 allows the page to serve as the upper level “menu,” where the various flags, logotypes or nameplates image objects are actually hyperlinks to the particular newspaper pages also hosted on server 72. For example, a user selection of “The Sentinel” link 112 will result in the browser displaying the web page of FIG. 3. Alternative formats and examples of aspects of the present invention may also be found at www.rockawave.com, which is hereby incorporated by reference, and a portion of the HTML code for that site being depicted below for purposes of illustration:

<!DOCTYPE HTML PUBLIC “-//W3C//DTD HTML 3.2 Final//EN”><html>
<head></head>
<BODY><TABLE ALIGN=LEFT CELLPADDING=3><TR><TD ALIGN=LEFT VALIGN=TOP
WIDTH=80><center>
<a HREF=“HTTP://www.our-hometown.com”><img SRC=“/graphics/newstown.gif”
BORDER=0 height=70 width=76></a><a HREF=“/cgi-
bin/reloc.exe?http://www.wunderground.com/US/NY/NEW_YORK.html”>
<img src=“http://banners.wunderground.com/banner/smalltemptr/US/NY/NEW_YORK.gif”
height=“28” width=“53” border=“0” alt=“Weather”></a>
<br>
. . .
<A HREF=“/public/AdDsp.cfm?/advertising/large/dunne001230_02.igf?20022282059”><IMG
SRC=“/advertising/small/dunne001230_02.gif?20022282059” width=200 height=140
BORDER=0></A><br><br>
<A
HREF=“/public/AdDsp.cfm?/advertising/large/MedportArverne011020colorad.gif?20022282059”><IM
G SRC=“/advertising/small/MedportArverne011020colorad.gif?20022282059” width=200 height=290
BORDER=0></A><br><br>
<A
HREF=“http://www.rockawave.com/public/submitemail.cfm?publisher=www.rockawave.com”><IMG
SRC=“/advertising/small/NewsFree.gif?2001112111” width=200 height=261
BORDER=0></A><br><br>
<A HREF=“https://www.our-
hometown.com/public/subscriptionorder.cfm?publisher=Rockawave”><IMG
SRC=“/advertising/small/Subscribe.gif?200110301133” width=200 height=151
BORDER=0></A><br><br>
<center><font size=2><a href=“http://www.our-hometown.com/publisher/patent.htm”>System
and Method for Display <br>Ads have a Patent Pending.<br>Click Here for More
Information</A><br></font></center><IMG SRC=“/Graphics/adspacer.gif” border=“0” WIDTH=“1”
height=“158”><br>
</TD></TR></TABLE></body></html>
<!-- This page has been formatted by Frame++, Copyright. Our-Hometown, Inc. 2001 −−>
<!-- url: /rockawave −−>
<!-- Publisher: Wave of Long Island −−>
<!-- Processing Time: 485 milliseconds −−>

Accordingly, the web page 108 is a structure having not only particular display characteristics and embedded images itself, resulting in a browser displaying the various objects described, but embedded within the structure is particular functionality associated with each of the object types (e.g., hyperlinks).

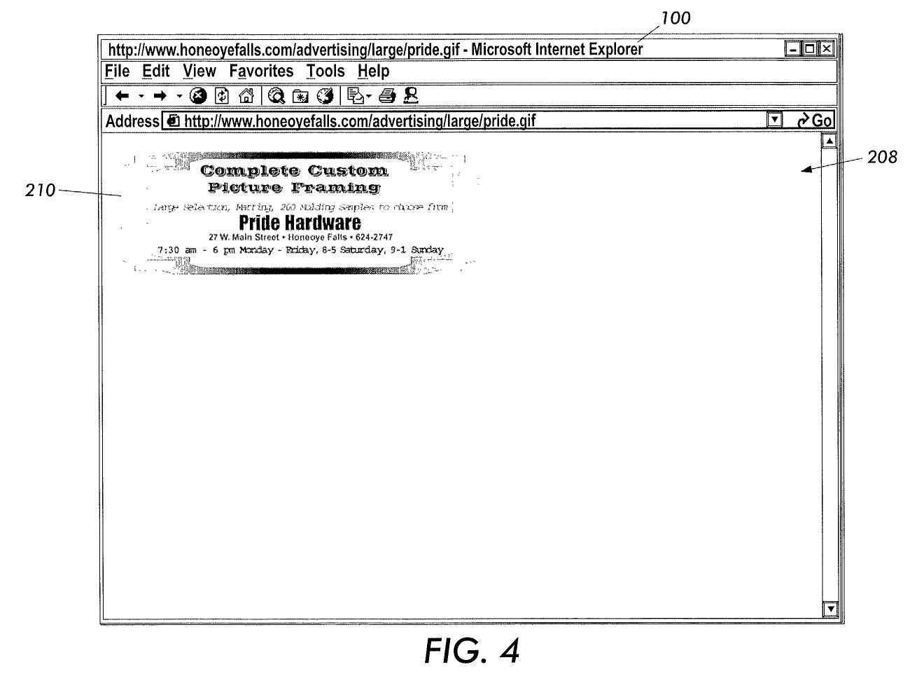

Referring also to FIGS. 3 and 4, there are depicted exemplary illustrations of user-interface screen scenes that would be depicted to a user who has selected hyperlinks within page 108 of FIG. 2. More specifically, FIG. 3 depicts a web browser window 100 that shows a web page 158 associated or linked via “The Sentinel” link on web page 108. The page, residing at the honeoyefalls.com upper level domain on the world-wide web, includes a region 160 having a plurality of linked buttons therein, organized under the headings or classifications “News,” “Advertising,” “Services,” “Towns,” “Fun,” and “Search Archive” as easy indexes to the button objects below each heading. Again, as previously noted, the particular button characteristics displayed on a newspaper's web site are determined by a “button” file that is read by the operating software and incorporated into a web page as it is created.

Also included on web page 158 is flag image 162, banner advertisement 164 and display advertisement objects 168 and 170. The display advertisement objects are generally depicted as reduced-size images of actual print advertisements run by the newspaper. However, in the event of a small (e.g., business card sized) print advertisement, it will be appreciated that the display advertisement size represented in objects 168 or 170 may be same or larger in order to fit within the defined display advertisement region.

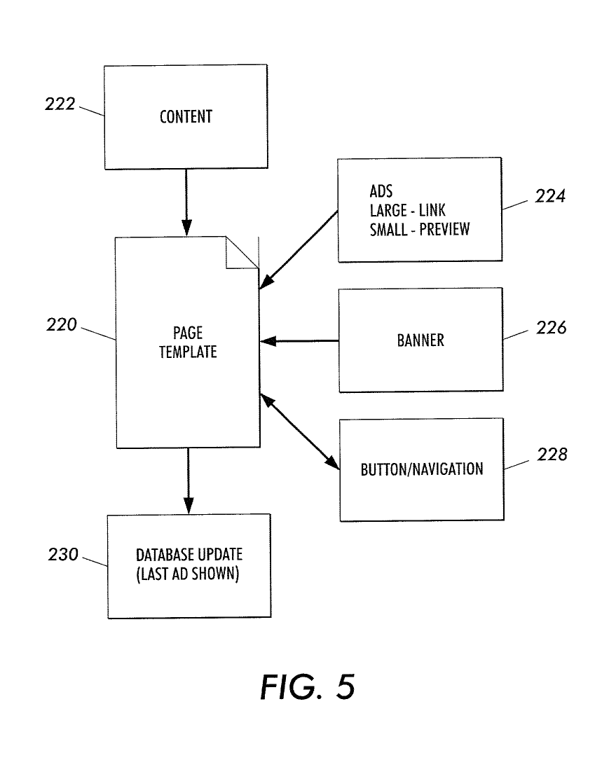

The creation or assembly of a web page such as that depicted in FIG. 2 is accomplished by the HTTP server software resident on server 72. As illustrated in FIG. 5, a page design or layout template 220 is used to control the creation or serving of the web page. In particular, template 220 directs the HTTP server software to access content 222, advertising 224 (full-size and display ad size), banners 226, and button/page navigation information 228, all of which may be employed to generate or “serve” the page to a requester. It will be further appreciated that the button/page navigation information is dependent upon the page layout, and that the navigational details of a particular newspaper or page within the web site will be used to update the navigational information. When the page is served, and when the page is updated (advertising, content, etc.) using the template 220, the database 74 is also updated as represented by block 230. The database 74 may be updated, for example, to reflect the last display ad shown at the top of the display ad region, thereby facilitating rotation of the advertisements. It will be further appreciated that based upon the template, and desired advertisement sequencing, other data may be updated or stored in the database.

The following is a portion of the HTML code generated by server 72 and employed to produce the scene displayed as web page 158:

<!DOCTYPE HTML PUBLIC “-//W3C//DTD HTML 3.2 Final//EN”>
<HTML>
<HEAD>
<title>The Mendon, Honeoye Falls, lima Sentinel</title>
<meta name=“description” content=“Weekly Online Community Newspaper providing up to
date local news and events to the Honeoye Falls area in upper New York”>
<meta name=“keywords” content=“14472 NY Western Local news school business upstate
new york finger lakes history events links Avon Mendon Honeoye Falls Lima Rush pictures photos
articles headline column sports community archives information newspaper homes monroe county”>
</HEAD><body bgcolor“#FFFFFF”><TABLE ALIGN=LEFT CELLPADDING=3>
<TR><TD ALIGN=LEFT VALIGN=TOP WIDTH=80>
<center><a HREF=“/cgi-bin/reloc.exe?HTTP://www.our-hometown.com”><img
SRC=“/newstown.gif” BORDER=0 height=70 width=76></a>
<a HREF=“/cgi-bin/reloc.exe?http://www.wunderground.com/US/NY/Honeoye_Falls.html”>
<img src=“http://banners.wunderground.com/banner/smalltemptr/US/NY/Honeoye_Falls.gif”
height=“28” width=“53” border=“0” alt=“Weather”></a>
<br>
<b>1/25/2001</b></center>
<table BORDER=0 CELLSPACING=0 CELLPADDING=0 BGCOLOR=“#000000”>
<tr>
<td>
<table BORDER=0 CELLPADDlNG=0 WIDTH=“90” CELLSPACING=1 BORDER=0>
<tr>
<td bgcolor“#993366”><font size=“2” color=“White”><b>News</b></font></td>
</tr>
<tr>
<td bgcolor=“#f5ecde”><A HREF=“/News/2001/0125/Front_Page.html”style=“text-
decoration: none;“><font size=“2” color=“black”><center><b>Front
Page</b></center></font></A></td>
. . .
<font size=1 color=“black”><center>Copyright&copy2001<br>The Sentinel<br>All Rights
Reserved</center></font>
</td></tr>
<tr><td bgcolor=“#f5ecde”>
<a HREF=“mailto:sentinel@frontiernet.net” style=“text-decoration: none;”><center><b>E-
mail Us</b></center></a>
</td></tr>
<tr><td>
</td></tr>
</table>
</table>
</table>
<table CELLSPACING=2 CELLPADDING=0>
<tr>
<td><A HREF=http://www.expressinsures.com/ TARGET=“_top”><IMG
SRC=http://www.honeoyefalls.com/Banners/expressinsurance_banner.jpg border=“0”
WIDTH=“468” HEIGHT=“60”></A><BR>
</td>
</tr>
<tr>
<td>
<img src=“/sentinel-bnr.gif” ALT=“The Mendon, Honeoye Falls, lima Sentinel” width=“468”
height=“60”border=“0” alt=“ ”>
</td>
</tr>
</table>
</TD></TR></TABLE><TABLE BORDER=0 ALIGN=LEFT WIDTH=55%><TR><TD><img
src=“/Graphics/adspacer.GIF” width=“350” height=“1” border=“0”><BR>
<center>
<p align=“center”></p>
<table cellspacing=“0” cellpadding=“6” align=“CENTER”>
<tr>
<td valign=“TOP”><table border=“0” cellspacing=“0” align=“CENTER”>
<!--table????−−>
<tr align=“CENTER”>
<td align=“CENTER”><font size=“5”><B>Front Page</b></font><font size=“3”>. . .
<strong>January 25, 2001 </strong></font><p></p>
</td></tr>
</table>
<b><P>Car break-ins a chronic problem in Monroe
County<BR></b><br>&nbsp;&nbsp;&nbsp;&nbsp;&nbsp; &quot;We're getting killed with cars getting
broken into,&quot; laments Ed Ramsperger, a Crime Prevention Officer with the Monroe County . . .
address water rescue situations, and hold drills regularly.<a
HREF=“/news/2001/0125/Front_Page/Local_fire_companies_practice_water_rescue.0125.html”><br
> More . . . </a><br clear=all><br>
</td>
</tr>
</table>
</center>
</TD></TR></TABLE><TABLE ALIGN=LEFT><TR><TD WIDTH=200 valign=“top”>
<CENTER>Click ad for larger version<br></CENTER>
<A HREF=“/advertising/large/my_own_shop.gif”><IMG
SRC=“/advertising/small/my_own_shop.gif” width=200 height=200 BORDER=0></A><br><br>
<A HREF=“/advertising/large/pride.gif”><IMG SRC=“/advertising/small/pride.gif” width=200
height=67 BORDER=0></A><br><br>
<IMG SRC=“/Graphics/adspacer.gif” border=“0” WIDTH=“1” height=“733”><br>
</TD></TR></TABLE></BODY>
<!--URL is ‘/’−−>
<!-- url_to_file is 0 ‘e:\production\web sites\ourhometown\sentinel\index.html’−−>
<!-- domain is host-64-65-206-88.choiceone.net −−>
</HTML>
. . .

A user viewing web page 158 will also note that the display advertisements 168 and 170, as well as banner advertisement 164 are objects having active links. For example, if pointer 174 is moved to select display advertisement 170, web page 208 of FIG. 4 will be displayed by the browser window. Referring to FIG. 4, the browser window preferably displays at least an enlarged or full size image object 210 of the display advertisement 170 (FIG. 3) so that the image may be viewed, printed, or saved by the user at a computer workstation 60 or 62. As will be described below, the sizing of the display advertisement image 170 and position are determined in accordance with the layout of the web page as well as the size of the original advertisement in its print format (e.g., ½ or ¼ page).

It is also contemplated that the display advertisement 170 or the full size image object 210 may be linked directly to advertiser's websites. In the event that the preview of display advertisement is hyperlinked to the advertiser's website the larger display ad is not used. A further, optional, modification includes allowing advertisers to add other information on the HTML page displaying the full size image advertisement, such as: a link to the advertiser's website, a link to a mapping service that would display a map to their location and/or give directions; and other information and links about their service/products in text or image(s). Such information is contemplated as being in addition to the display ad image.

In addition, the present invention contemplates the use of a database of images 74, stored in a file system. Use of such a system speeds the access of the display advertisement images as compared to a program-generated page. Hence, in combination with text-based navigational features, quick textual content display, and reduced-size display advertising graphics, the pages served to users are not only laid out in an attractive manner, but the user is able to quickly review the material in a familiar format.

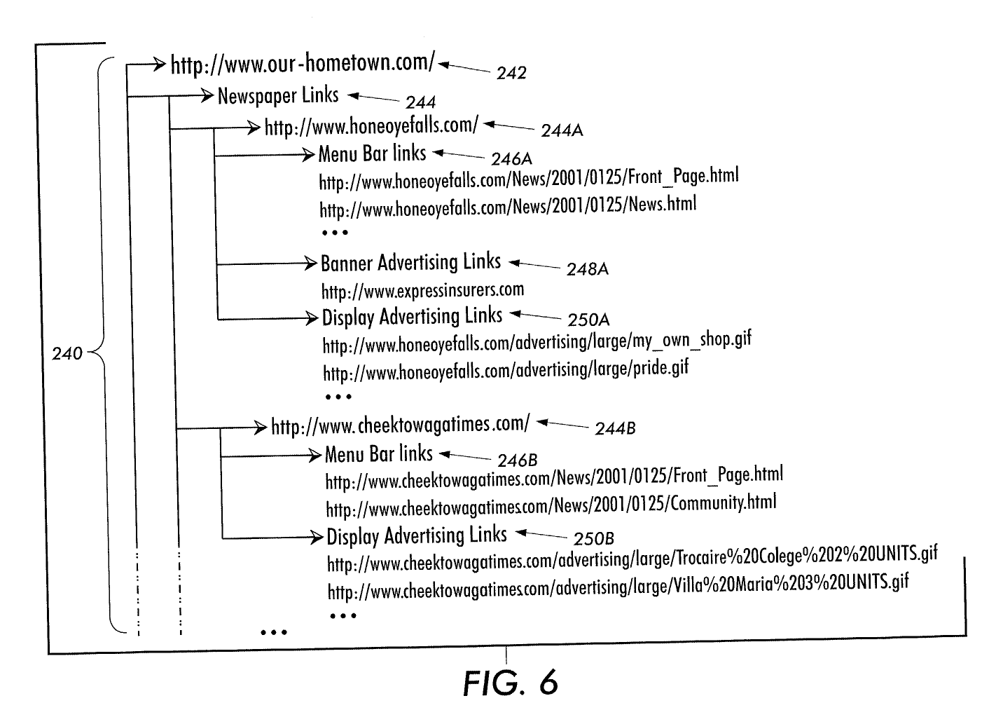

Referring to FIG. 6, there is depicted a menu hierarchy schema 240 for a newspaper and advertisement hosting service in accordance with an embodiment of the present invention as described above. At the top level 242 of the hierarchy, the newspaper hosting domain appears, followed by a plurality of newspaper links 244 (linked upper-level domains 244a, 244b). Each of the individual newspaper sites then has its specific set of link groups, which may include menu bar links 246, banner advertising links 248 and display advertising links 250 and others as desired by the particular newspapers. Under the display advertising links 250a for the honeoyefalls.com domain there are depicted two links corresponding with display advertisement images 168 and 170 of FIG. 3. These two links are used to display the full-size advertisement should a user make a selection on the reduced-size or preview display advertisements in FIG. 3. Thus, the newspaper is capable of displaying the advertisement in a manner in which users are accustomed to viewing advertisements—adjacent to news/editorial content.

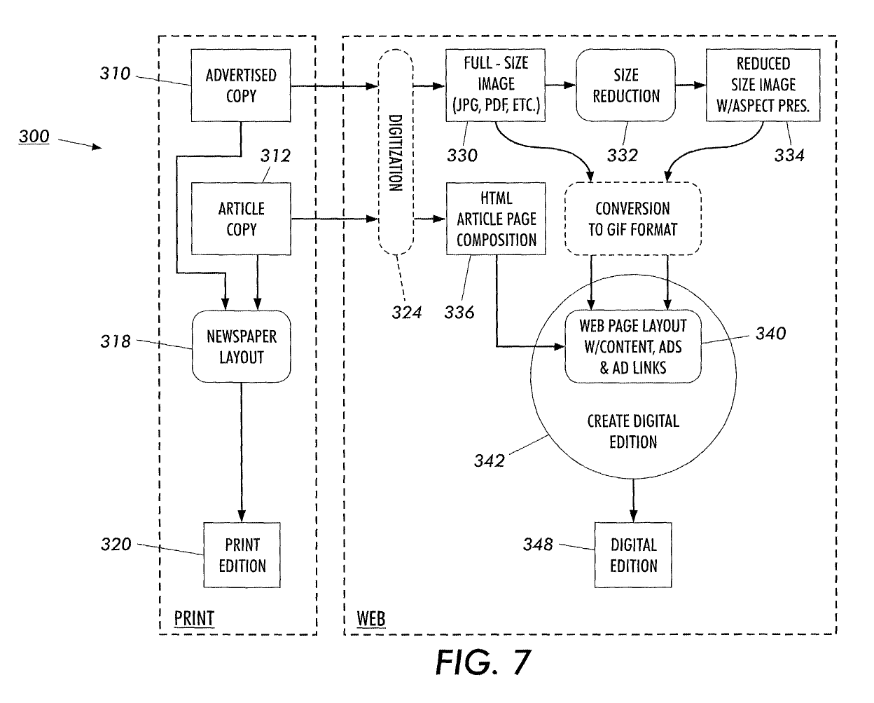

Turning next to FIG. 7 there is shown a schematic illustration of a display advertisement production system 300. More specifically, system 300 may be accomplished via the composition workstation(s) 60 associated with LAN 52 (FIG. 1). Referring to FIG. 7, along the left side of the figure is depicted a general representation of a traditional newspaper publication process, where advertising copy 310, news article and editorial or other content 312 is laid out in step 318 to compose one or more pages of a newspaper (daily, weekly, etc.) print edition 320.

As some newspapers are beginning to produce, or outsource the composition/hosting of on-line editions, it is believed valuable to have an easy replication of the news/article content as the text material can be readily converted (including digitization and optical character recognition) into a HTML format for insertion into a web page. Unfortunately, as traditional newsprint pages are converted to on-line, computer readable content they do not generally lend themselves to the inclusion or insertion of traditional display advertising, let alone advertising that is formatted for newsprint media (e.g., ⅛, ¼, ½ and full-page sizes). The present invention relies, on the other hand, upon the on-line format that is composed in a manner similar to traditional newsprint, where advertising is laid-out adjacent to a column-oriented article as depicted in FIG. 3, or in other pre-defined locations in relation to the news/editorial content.

Accordingly, the right side of FIG. 7 illustrates an embodiment of the method of the present invention employed to produce the layout of a digital newspaper edition such as found in FIGS. 3 and 4 described above. There, advertiser copy 310, having been digitized (if necessary at step 324) is rendered as a digital image such as graphic interchange format (GIF of .gif) or portable document format (PDF or .pdf) in a “full-size” file 330. Similarly, using an image size reduction operation 332, the same advertisement is also rendered in a reduced-size format that is referred to as a “preview” file 334. Both of the associated image files (preview and full-size) are rendered in a gif file format so as to allow the file to be received and viewed by most browsers. The preview file format preferably retains the aspect ratio of the original advertisement and generates previews with a common width or height so as to allow for easy placement along columns or rows, respectively. When the web page is being laid out, step 340, as part of the step of creating the digital edition 342, the HTML article content can be associated with the advertisements as previously depicted. Moreover, the process of the present invention, by retaining the advertisement aspect ratios, facilitates the placement of dissimilarly sized advertisements in the same column or other predefined locations on a web page.

As described herein, the present invention preferably uses existing display advertising hard-copy or other print-formatted copy to produce both full-size images and reduced-size or “preview” images that provide a best-fit or maintain the aspect ratio of the full-size advertisement, while reducing their size to fit into a web page. Such formatting, for example, allows placement at a position adjacent news/editorial content in a manner familiar to traditional readers. The web page is then composed using the news/editorial content in conjunction with the display advertisement.

Recent releases of Microsoft's Internet Explorer browser software (e.g., Release 6+) “shrink” the full size display advertisement image to fit the browser window. It will be appreciated that this automatic shrinking may not be desired when an ad image is bigger than the window, because the advertisement image may become unreadable at a smaller size. Even though there is an icon that the user could use to expand to full size and a “property” that allows this feature not to be used (but by default it is used), it is believed that most people would not recognize what the icon meant and/or not change the default properties to optimally display the full size display advertisement images (e.g., 210 in FIG. 4). Therefore, the present system further contemplates a change to the source code that generates the link to the larger image to call another program. This additional program then outputs HTML code that embeds the image. Because the recent release of the Internet Explorer browser never changes the image size of embedded images the embedding of the images eliminates the problem of automatic size reduction for the display advertisements.

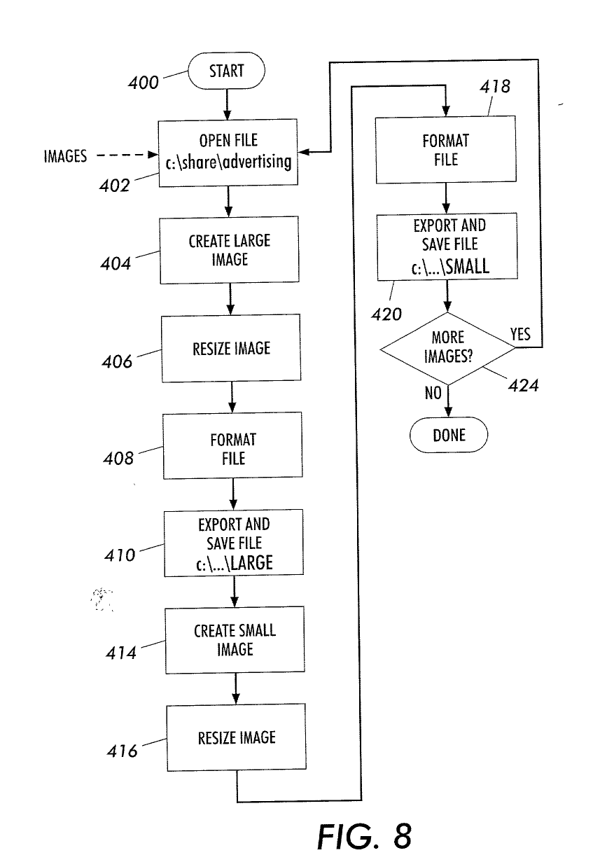

Turning lastly to FIG. 8, displayed therein is a detailed flow diagram depicting aspects of the steps followed in the creation of a digital or web edition of a newspaper, including preview images of advertisements in accordance with the present invention. Various aspects of the present invention are implemented using Adobe Photoshop software, and the script programming capabilities thereof, although it will be appreciated that alternative processing means may be created or employed to accomplish the same method. The following script is an exemplary illustration of the steps carried out with respect to the creation of images for the display advertising functionality of the present invention:

Convert Display Ads

V Batch

C:\SHARE\ADVERTISING

With Override Open

Using: action “Convert Small” of set “Our-Hometown.com”

To: C:\SHARE\ADVERTISING\small

With Override Save

V Batch

C: \SHARE\ADVERTISING

With Override Open

Using: action “Convert Large” of set “Our-Hometown.com”

To: C:\SHARE\ADVERTISING\large

With Override Save

Convert Small

Open

C: \share \advertising \FILENAME.pdf

As: PDF generic

Width: 200 pixels

Resolution: 72 per inch

Mode: RGB color

With Anti-alias

With Constrain Proportions

Page Number: 1

Export

Using: Save For Web

Format: GIF89a

Without Interlaced

Reduction Algorithm: Selective

Without Auto Reduce

Number Of Colors: 64

Dither Algorithm: None

Dither Amount: 0

Web Shift: 0

Lossy: 0

With Transparency

With Matte

Matte Color Red: 255

Matte Color Green: 255

Matte Color Blue: 255

Without Save HTML File

In: C:\share\advertising\small

Close

Saving: no

Convert Large

Open

C: \share \advertising \FILENAME.pdf

As: PDF generic

Resolution: 72 per inch

Mode: RGB color

With Anti-alias

Page Number: 1

Export

Using: Save F or Web

Format: GIF89a

Without Interlaced

Reduction Algorithm: Selective

Without Auto Reduce

Number Of Colors: 64

Dither Algorithm: None

Dither Amount: 0

Web Shift: 0

Lossy: 0

With Transparency

With Matte

Matte Color Red: 255

Matte Color Green: 255

Matte Color Blue: 255

Without Save HTML File

In: C:\share\advertisjng\large

Close

Saving: no

The illustration of FIG. 8 depicts the process of converting the image files and begins at step 400. Immediately thereafter, the image file is opened (and converted to an appropriate format if necessary) at step 402. Next, the full-size (generally larger) image files are created beginning at step 404. First the image is resized at step 406, if necessary, to fit within a browser window. Next, at step 408, the image is reformatted and is then exported and saved at step 410. The image file may be saved on a service bureau computer (not shown) for later loading to the database of host server 72 in association with a web site update. Subsequently, beginning at step 414 the images are processed to produce preview image files in accordance with their size. The size of the input image is determined at step 414 and subsequent processing of the image is accomplished in accordance with its size.

For example, the on-line newspaper may be set up in a manner where a 200 pixel column of display advertising is desired along the right side of the web page (e.g. FIG. 3). Thus, the image width must be scaled to provide a 200 pixel wide preview image. However, if the image width is scaled without a similar scaling of the image height, the proportions of the image may be changed. Thus, in this example, the entire image would be scaled by an amount necessary to cause the image width to be 200 pixels. It should be appreciated that the layout of the on-line newspaper may be modified, perhaps by adjusting the “template” used to compose the on-line edition, and that the associated display advertisements will then be processed in accordance with the area allocated for any display ads (which may be along a column or a row, or dispersed at specific locations within a page). In a preferred operation, one or more aspects of the image conversion are accomplished automatically using a computer system in order to speed the display advertisement creation process.

Once the display advertisement image has been resized at step 416, to fit within a designated preview advertisement region of a web page, the preview image is formatted at step 418 and is then exported and saved with other preview images at step 420. Again, the image file may be saved on a composition computer for loading to the database of host server 72. Alternatively, the system may be automated so that processed display advertisement image files, including full-size images and associated preview images, are automatically uploaded by the composition computer and stored in the image database 74 and are then made “live” when the linking HTML web page is uploaded. Lastly, as depicted by test block 424, the system determines whether additional images are available for processing. If so, the process is repeated beginning at step 402 with the next file, otherwise, processing is completed.

Another aspect of the present invention is one in which a plurality of display advertisers may have their respective preview image display advertisements depicted at the top or other preferred location on the web page in an automatically rotating fashion. For example, referring briefly to FIG. 3, preview display advertising images 168 and 170 may periodically exchange places so that each appears at the top of the advertising column for a specified period of time, such as each time the page is served. Although such a system may be implemented manually, where an administrator manually changes the order of appearance occasionally, an embodiment of the present invention implements the control of such features in the operating software running on host server 72 where it may be an automated process accessing the image file database. In an alternative embodiment, the display advertisement positions may be changed hourly or daily, or even by the number of hits to a web page (e.g., change order every ten hits). It is also conceivable that the top one or more positions in a column are fixed during a particular run of the digital edition (e.g., one week for a weekly newspaper) where the position can command a higher advertising rate, and where preview images lower in the advertising column are then rotated periodically. The present invention further contemplates the operating software being able to place or locate display advertising by the on-line newspaper section being displayed section (e.g. placement in news, sports, etc.), and showing current advertisements even when viewers look at archives.

The present invention further contemplates evenly distributing advertising displays over a given period. For example, a customer may want the ads to be displayed over a two week period and is willing to pay for one thousand displays. With the current system, if a site receives a significant amount of traffic, the one thousand ads may be used up in a single day. The proposed improvement would trickle out the displays over the two week period, thereby meeting both the customers period and number of display requirements without wasting displays.

Furthermore, statistics and billing information collected with respect to such display advertisements may include: 1) reports indicating the number of times ads are displayed, the page(s) they are displayed on and, the number of times full size images are displayed at the viewer's request, etc.; and 2) generation and tracking of bills to advertisers. It will be appreciated that the database 74 (FIG. 1) may be employed to track and report such information using well-known programming techniques. It should also be noted that the database operation may be automated, or directly associated with other commercially available of custom software to achieve the functionality suggested herein. For example, although the system code contained herein does not report which pages any specific display ad appeared on, such a modification is contemplated as an improvement, and would provide a list of pages a specific display appeared on over a given period along with the count of the number of times it appeared on each page listed in order to provide complete information for an advertising customer. Similarly, a system incorporating aspects of the present invention could print reports and/or bills for advertisers when “advertising campaigns” are completed if the proper information is collected.

The system and methods described herein result in an improved layout for web sites, particularly sites associated with newspapers and newsletters, where an advertiser is not restricted to a banner or other traditional web advertising formats. Furthermore, the preview images that appear on the pages are also hyperlinks to the full-size image, so that a user can review, in a larger format, the details of the advertisement. Accordingly, the system produces digital edition web pages that incorporate preview advertising images that are “in the reader's face.” Additional preview image alternatives exist, and the system may be programmed to allow tiling of advertisement previews, as well as diverse placement and sizing options for the previews.

In recapitulation, the present invention is a method and apparatus for preparing a web page for a digital edition of a newspaper, newsletter, or magazine using print media input for both news/editorial or other content and advertisement, so that a publisher may offer to advertisers both hard copy print and web site advertising opportunities without requiring the advertiser to alter their advertising copy. The method uses existing display advertising, such as hard copy or other print-formatted copy, to produce both full-size images and reduced-size or “preview” images that provide a best-fit and/or maintain the aspect ratio of the full-size advertisement, while reducing their size to fit into a web site. For example, the advertising copy may be programmed to appear at a position adjacent news/editorial content in a manner familiar to readers (e.g., right-hand column). The web page is then composed using the news/editorial content in conjunction with advertisement.

It is, therefore, apparent that there has been provided, in accordance with the present invention, a system and method for preparing a web page for a digital edition of a newspaper or magazine, where the page utilizes print media input for both content and advertisement. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

I claim:

1. An on-line newspaper publishing system for preparation of one or more publications, including:
a networked host server;
a composition computer connected to said host server; and
an image database, associated with the server and accessible by the composition computer, that defines at least the following,
content to be prepared for publication in a digital edition hosted on the host server;
at least one layout template wherein the template defines at least a region on a web page for the display of a preview image of a display advertisement;
image files, including images of full-size display advertisements and corresponding reduced-size preview images; and
browser-readable code representing a web page, wherein the web page has at least one link to an image file.

2. The on-line newspaper publishing system of claim 1, wherein the preview images are automatically produced from the full-size image files.

3. The on-line newspaper publishing system of claim 2, wherein the preview images are produced in accordance with at least one predetermined size requirement.

4. The on-line newspaper publishing system of claim 3, wherein the predetermined size requirement is defined by region on a web page for the display of a preview image of a display advertisement as dictated by the at least one layout template.

5. The on-line newspaper publishing system of claim 1, wherein the preview images are automatically associated with content in a web page viewable by a networked computer connected to the host server, and where the preview images are also hyperlinks to the full-size display advertisement images.

6. The on-line newspaper publishing system of claim 1, wherein the preview images are periodically moved relative to one another on the web page.

7. The on-line newspaper publishing system of claim 1, wherein the location of the preview images is determined as a function of the category of the web page.

8. The on-line newspaper publishing system of claim 1, wherein the content is archival content and wherein the image files, including images of full-size display advertisements and corresponding reduced-size preview images, are current advertisements.

9. A method of preparing an on-line news publication via an electronic publishing system in a computer, the method including the steps of:
collecting advertiser digital copy from a print media source;
creating, using an image size reduction operation, a reduced-size preview image of the advertiser digital copy, wherein at least one dimension of the preview image is determined in accordance with a predetermined size;
associating text-based content with the preview image in a web page, wherein the preview image is a selectable object that is linked to a full-size image of the advertiser copy; and
publishing the web page.

10. The method of claim 9, further including the step of digitizing the advertiser hard copy from a print media source to create the advertiser digital copy. as a digital image.

11. The method of claim 10, wherein the step of digitizing the advertiser hard copy creates a digital image in a graphics interchange file format (.gif).

12. The method of claim 9, wherein the step of creating a reduced-size preview image includes retaining the aspect ratios of the digital copy so as to facilitate the placement of dissimilarly sized advertisements in locations having a common dimensional limitation.

13. A method of preparing an on-line news publication web page, including display advertising for distribution via a network, the method including the steps of:
determining the size of full-size display advertisement images to be incorporated into the web page;
successively opening a plurality of the advertisement images, and resizing at least one such image so as to adjust the size to meet at least one dimensional requirement of the web page, and saving the resized image data as a preview file;
incorporating the preview file into the web page; and
uploading the web page for access by other computers.

14. The method of claim 13, wherein the one dimensional requirement is an image width limitation.

15. The method of claim 14, wherein the resized image width limitation is a 200 pixel column width limitation associated with the web page layout.

16. The method of claim 13, wherein the resized image is automatically scaled in at least two dimensions in accordance with the at least one dimensional requirement.

17. The method of claim 13, wherein the preview files are automatically associated with content in a web page and where the images within the web page are also hyperlinks to an associated full-size image.

18. The method of claim 13, wherein the preview files are periodically moved relative to one another on the web page.

19. The method of claim 13, wherein the location of the preview images is determined as a function of a category of the web page.

20. The method of claim 13, wherein textual content displayed on the web page is archival content and wherein the image files, including images of full-size display advertisements and corresponding reduced-size preview images, are current advertisements.
